(19) United States
(12) Patent Application Publication
(10) Pub. No.: US 2009/0151850 A1
(43) Pub. Date: Jun. 18, 2009

(54) Process for fabrication of a fully dense electrolyte layer embedded in membrane electrolyte assembly of solid oxide fuel cell

(76) Inventors: WEI-XIN KAO, Taoyuan County (TW); Maw-Chwain Lee, Taoyuan County (TW); Tai-Nan Lin, Taoyuan County (TW); Chun-Hsiu Wang, Taoyuan County (TW); Yang-Chuang Chang, Taoyuan County (TW); Li-Fu Lin, Taoyuang County (TW)

Correspondence Address: MICHAEL LIN, 5F 79 Roosevelt Rd. Sec. 2, TAIPEI, 106, TW

(21) Appl. No.: 11/956,342

(22) Filed: Dec. 14, 2007

(51) Int. Cl. B32B 37/06

(52) U.S. Cl. 156/64

(57) ABSTRACT

This invention describes the process for fabrication of a fully dense electrolyte layer (8YSZ/GDC/LSGM) embedded in a high performance membrane electrolyte assembly (MEA) (Unit Cell) of Solid Oxide Fuel Cell. An air-tight electrolyte layer (8YSZ/GDC/LSGM) is mainly prepared via tape casting technique and modified by thin film technologies, such as sputtering coating, spin coating, plasma spray/Coating etc., as well as combined with the sintering scheme and operation control. The gas permeability of electrolyte layer is less than 1×10⁻⁶ L/cm²/sec.

### BACKGROUND OF THE INVENTION

1. Field of the Invention

The invention relates to a manufacturing technology for the electrolyte layer in a solid oxide fuel cell (SOFC). It refers to a membrane fabrication method that primarily uses tape casting process and is assisted with processes like sputtering coating, screen printing, spin coating or plasma spray coating. With design and control for sintering condition, the invention enables a process for successful preparation of fully dense electrolyte layer that will be embedded in a high performance membrane electrolyte assembly.

2. Description of the Prior Art

With rising oil price and growing consciousness of environmental protection, renewable energy technology is one of the most important technologies in the century. Solid oxide fuel cell is a power generation system with high efficiency, low pollution and diversified energy source. It has become the power generation system that has the most development potential because its features like simple material composition, modulized structure and stable and sustainable power generation.

The operation temperature for an Electrolyte Supported Cell (ESC) that uses YSZ for electrolyte support is 800˜1000° C. The thickness for its electrolyte layer is about 150˜300 μm. This is the first-generation SOFC-MEA. The operation temperature for an Anode Supported Cell (ASC) that uses anode material, NiO+YSZ, for anode support is about 650˜800° C. The thickness for its electrolyte layer (YSZ as primary material) is about 10 μm. This is the second-generation SOFC-MEA. NiO+8YSZ is the anode material for ASC/ESC. The cathode material is mainly LSM and LSCF and about 30˜60 μm thick. Many researchers in the world are actively developing new electrolyte materials and cathode materials. It is expected that new materials could lower the operation temperature for SOFC-MEA to about 500˜700° C. Then, the parts in SOFC stack, like interconnector, could use metallic materials to replace ceramic materials. The benefits include not only easy manufacturing but also increased mechanical strength/stability/durability, as well as decreased overall cost for SOFC. The technological development in universities and national laboratories emphasize material development, which expects new materials to lower resistance, increase ionic/electrical conductivity, and improve SOFC power.

### SUMMARY OF THE INVENTION

The main objective for the invention is to develop the manufacturing process for a fully dense electrolyte layer for SOFC-MEA.

To achieve the above objective, a tape casting process is proposed as the membrane fabrication method, which is also assisted with sputtering coating, screen printing, spin coating or plasma spray coating. The mentioned process under specially designed and controlled sintering condition can successfully produce a fully dense electrolyte layer. Take Anode Supported Cell (ASC) as example. The invented process uses tape casting to produce electrolyte green tape, which through lamination is securely put onto anode green tape. The anode/electrolyte composite green tape is subject to high-temperature sintering to produce half cell. Then, screen printing is used to coat cathode layer onto the electrolyte surface of the half cell. This will conclude the manufacturing of a fully dense electrolyte layer for a solid oxide fuel cell that is also anode supported cell. The SOFC-MEA produced from this process has high performance, durability and stability, which can be verified by performance test of SOFC-MEA.

### BRIEF DESCRIPTION OF THE DRAWINGS

The present invention will be apparent to those skilled in the art by reading the following description of a preferred embodiment thereof, with reference to the accompanying drawings, in which:

FIG. 1: a simple illustration for the manufacturing process in the invention;

FIG. 2: SEM picture for cross-sectional microstructure of a completed solid oxide fuel cell by membrane technology at specially designed and controlled sintering condition; and

FIG. 3: testing result for the electrical performance for the solid oxide fuel cell in the invention.

### DETAILED DESCRIPTION OF THE PREFERRED EMBODIMENT

The invention is to produce planar solid oxide fuel cell (SOFC-MEA), a unit cell, which has embedded fully dense/zero gas leakage rate or airtight electrolyte (like 8YSZ/GDC/YDC/LSGM etc.). The implementation for such process is described as follows:

Step 1: Use tape casting process to produce planar SOFC-MEA anode and electrolyte green tape. Cut and laminate the electrolyte green tape (5˜300 μm) and anode green tape (600˜1200 μm) to produce SOFC half cell. Conduct sintering at about 1200° C.˜1600° C. (preferably at 1500° C.) for several hours (more than 3 hours) to produce the first-stage ceramic half cell. In this stage, the electrolytes can be YSZ, GDC, YDC, SmDC and LSGM. Use scanning electronic microscope (SEM) to analyze the microstructure for the half cell to assure the electrolyte layer reaches a microstructure that is open pore free and fully dense.

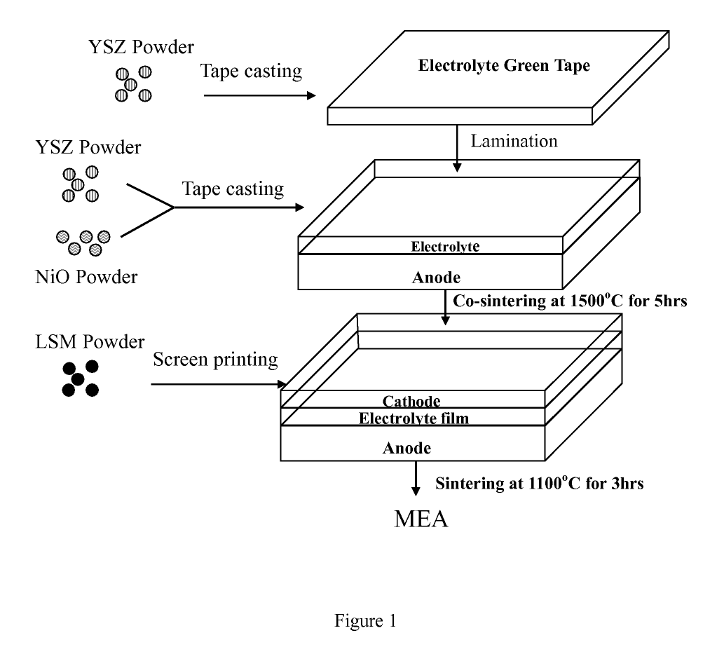

Step 2: On the electrolyte layer of the half cell, use screen printing process to build a porous cathode layer (usually the material is LSM or LSCF). Then conduct sintering at about 1200° C. for about 3 hours to complete the manufacturing of SOFC-MEA. The above process is to manufacture SOFC-MEA that has a fully dense and airtight electrolyte layer. A simple process flow diagram for Step 1 and Step 2 above is shown in FIG. 1. The following describes in details the embodiment for the invention:

### Embodiment 1

Step 1: A process to manufacture SOFC-MEA for solid oxide fuel cell (unit cell) that has a fully dense/airtight electrolyte layer (8YSZ/GDC/LSGM). The anode for this MEA is made from 50 wt % NiO+50 wt % 8YSZ and a specific amount of pore former (graphite). Tape casting process is used to produce electrode green tape. Lamination process makes the tape 1000 μm thick and 5×5 cm²˜10×10 cm² in size. The electrode green tape can be of anode or electrolyte green tape. Its material can be, but not limited to, YSZ+NiO, GDC+NiO, LSGM+NiO, SDC+NiO, YDC+NiO and YSZ, GDC, LSGM, SDC, YDC et al, respectively.

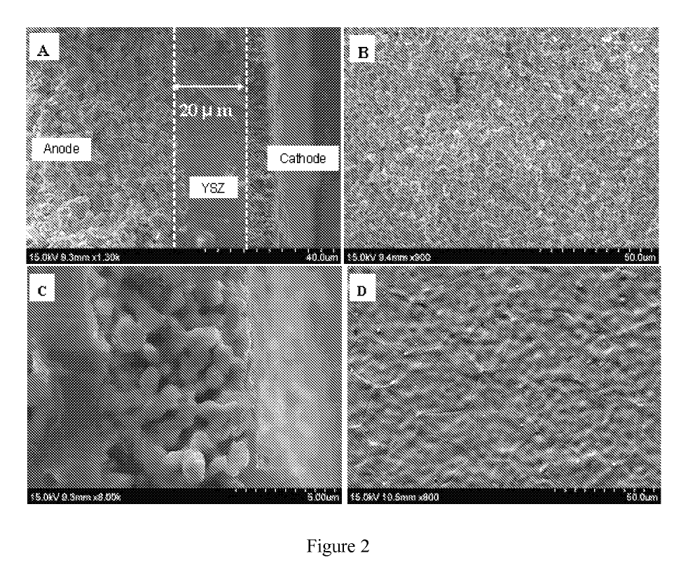

Step 2: Build the electrolyte green tape in membrane (5˜300 μm) firmly onto the electrode to produce SOFC half cell. Conduct sintering at about 1200° C.˜1600° C. (preferably 1400° C.) for several hours (more than 3 hours) to produce ceramic half cell in the first stage. Then conduct SEM analysis on microstructure to assure that the electrolyte layer has reached the microstructure that is open pore free. As shown in FIG. 2, the thickness of electrolyte layer is about 20 μm, which is a fully dense and airtight structure that can meet the requirement for SOFC-MEA electrolyte layer. The remaining closed fine pores do not affect the requirement for zero gas leakage rate.

Step 3: To assure the airtightness for the electrolyte layer, measure the gas leakage rate for the half cell obtained from Step 2. When the gas leakage rate is below 1×10⁻⁶ L/cm²/sec, it is to assure that the electrolyte layer is fully dense. The half cell with fully dense electrolyte layer is named HC-fd.

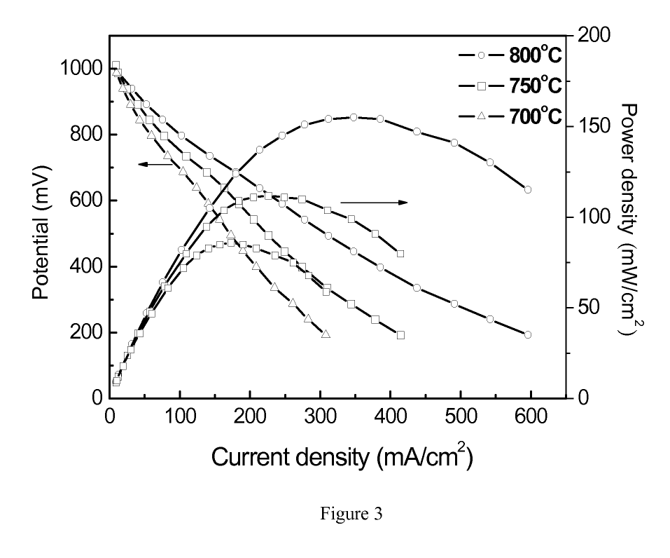

Step 4: On the electrolyte layer of HC-fd, use screen printing process to build on a porous layer of cathode LSM material. Then conduct sintering at about 1200° C. for 3 hrs. The sintering temperature rising/dropping rate can be, but not limited to, 3° C./min. This will complete the manufacturing of high-performance SOFC-MEA (Unit cell). The microstructure for the unit cell analyzed by SEM is shown in FIG. 2. The testing result for electrical performance for the produced SOFC-MEA is shown in FIG. 3. It indicates that OCV (1.037˜1.016V) has reached the theoretical value, maximum power density is larger than 150 mW/cm, indicating the excellence of the manufacturing process, innovation and technical criticalness for the invention have met the patent requirements. Therefore, the application is submitted.

The above description is only for an embodiment of the invention, but not to limit the scope of the invention. Those modifications and changes with equivalent effect to the description of the invention shall be all covered in the scope of the invention.

What is claimed is:

1. A manufacturing process for producing a planar solid oxide fuel cell (SOFC-MEA) having a fully dense electrolyte layer, the process uses tape casting process to produce planar SOFC-MEA anode and electrolyte green tapes, and then cuts and laminates the electrolyte green tape and anode green tape to produce SOFC half cell, under specially designed and controlled sintering condition, the process can produce planar solid oxide fuel cell that has a fully dense and airtight electrolyte layer (8YSZ/GDC/LSGM), comprising the following steps:
a. Using tape casting process to produce planar SOFC-MEA anode and electrolyte green tapes;
b. Building of the electrolyte green tape thin layer onto the electrode green tape and through lamination with proper pressure, temperature and system vacuum, produce SOFC green half cell;
c. Using lamination technology the green tapes of electrolyte and electrode are tightly combined; the anode/electrolyte composite green tape is subject to high-temperature sintering to produce ceramic half cell, it is about 1500° C. for 5 hours; SEM is used to inspect the result to assure the full densification of electrolyte layer, if a fully dense structure is achieved, go to Step d, if open pores still exist, use spin coating or sputtering coating processes for improvement or adjust sintering condition until fully dense electrolyte layer is achieved, then the half cell is named HC-fd;
d. Using screen printing to build a layer of cathode material onto the electrolyte layer of HC-fd., and conducting sintering at about 1200° C. for about 3 hours to complete the manufacturing of unit cell, sintering temperature rising/dropping rate is, but not limited to 3° C./min;
e. Conducting testing on the produced unit cell for electrical operation and power density measurement to verify its electric performance.

2. As described in claim 1 the process for producing a planar solid oxide fuel cell having a fully dense electrolyte layer, wherein the electrolyte materials can be YSZ, GDC, LSGM, SDC and YDC etc., but not limited to these.

3. As described in claim 1 the process for producing a planar solid oxide fuel cell having a fully dense electrolyte layer, wherein the electrode green tape to prepare SOFC in Step a can be anode or electrolyte green tape, the materials can be, but not limited to, YSZ+NiO, GDC+NiO, LSGM+NiO, SDC+NiO, YDC+NiO and YSZ, GDC, LSGM, SDC, and YDC.

4. As described in claim 1 the process for producing a planar solid oxide fuel cell having a fully dense electrolyte layer, wherein Step a uses tape casting process to produce electrode green tape for SOFC; the anode catalytic material, such as NiO, and the electrolyte weight ratio can be, but not limited to, 30˜60 wt %.

5. As described in claim 1 the process for producing a planar solid oxide fuel cell having a fully dense electrolyte layer, wherein Step a uses tape casting process to produce electrode green tape for SOFC; the anode catalytic material can be, but not limited to, NiO.

6. As described in claim 1 the process for producing a planar solid oxide fuel cell having a fully dense electrolyte layer, wherein Step b builds electrolyte membrane green tape onto electrode green tape, or electrode membrane green tape onto the electrolyte green tape.

7. As described in claim 1 the process for producing a planar solid oxide fuel cell having a fully dense electrolyte layer, wherein the process in Step b to build SOFC electrolyte layer onto electrode layer can be, but not limited to, lamination technology for two green tapes, the lamination conditions can be, but not limited to, 2000˜21500 psi, 50˜100° C. and system vacuum about 1˜10⁻⁶ torrs.

8. As described in claim 1 the process for producing a planar solid oxide fuel cell having a fully dense electrolyte layer, wherein the sintering process for half cell in Step c can be, but not limited to, 1500° C. and 5 hours, the sintering equipment can be, but not limited to, high-temperature furnace oven that circulates air or other gases.

9. As described in claim 1 the process for producing a planar solid oxide fuel cell having a fully dense electrolyte layer, wherein the process in Step d to use screen printing to build a layer of cathode material onto the electrolyte layer of HC-fd., other processes like sputtering coating, plasma spray coating and spin coating are also included.

10. As described in claim 1 the process for producing a planar solid oxide fuel cell having a fully dense electrolyte layer, wherein the sintering process in Step d can be, but not limited to, 1200° C./3 hours, with sintering temperature rising/dropping rate, but not limited to, 3° C./min.

11. As described in claim 1 the process for producing a planar solid oxide fuel cell having a fully dense electrolyte layer, wherein Step d uses screen printing to build a layer of cathode material onto electrolyte layer of HC-fd., cathode material can be, but not limited to, LSM and LSCF etc.

12. As described in claim 1 the process for producing a planar solid oxide fuel cell having a fully dense electrolyte layer, wherein Step d uses screen printing to build a layer of cathode material onto electrolyte layer of HC-fd., the thickness for cathode layer can be, but not limited to, 30˜50 μm.

13. As described in claim 1 the process for producing a planar solid oxide fuel cell having a fully dense electrolyte layer, Step c uses SEM to inspect the microstructure of half cell and assure the full densification of the electrolyte layer, including measurement of gas leakage rate, which is under 1×10⁻⁶ L/cm²/sec for fully dense/airtight electrolyte layer.
